(19) United States
(12) Patent Application Publication
(10) Pub. No.: US 2006/0038048 A1
(43) Pub. Date: Feb. 23, 2006

(54) Fragmenting devices for shredding paper and breaking compact discs

(76) Inventor: Emily Lo, Hsin Chuang City (TW)

Correspondence Address: Keith Kline;PRO-TECHTOR INTERNATIONAL SERVICES, 20775 Norada Court, Saratoga, CA, 95070-3018, US

(21) Appl. No.: 10/923,922

(22) Filed: Aug. 21, 2004

(51) Int. Cl. B02C 19/00

(52) U.S. Cl. 241/100; 241/236

(57) ABSTRACT

Fragmenting devices for shredding paper and breaking compact discs comprising a compact disc cutting tool set configured at a side of and linked up by means of a connecting gear to a cutting tool set of a conventional paper shredder. The compact disc cutting tool set is constructed to include two juxtapositioned cylindrical rotary cutters, and pressed grains are defined on surfaces of the two rotary cutters. A compact disc is inserted between the two rotary cutters through a compact disc insertion opening defined in a top surface of a top cover, and thereupon the pressed grains on the surface of the cutting tools mash and break up the compact disc. The present invention is characterized that a cutting tool set for breaking compact discs is shorter than a cutting tool set for shredding paper, and thereupon the present invention can save the costs of produce.

### BACKGROUND OF THE INVENTION

(a) Field of the Invention

The present invention relates to paper shredders, and more particularly to providing an independent paper shredder cutting tool set and an independent and shorter compact disc breaker cutting tool set, whereby the cutting tool sets can separately fragment sheets of paper and compact discs respectively therewith.

(b) Description of the Prior Art

Referring to FIGS. 1 and 2, which show a paper shredder of the conventional form provided with a paper shredder opening 100 and rotary cutters 200, which are only able to shred sheets of paper, and are unable to mash compact discs. Although there are businesses that additionally install another compact disc breaker opening to the paper shredder, whereby the two openings collectively utilize the same rotary cutters 200 to shred the sheets of paper and the compact discs. Thus, the commonly used two sets of rotary cutters 200 must bear variant usage which easily results in damage to the rotary cutters 200, and thereby reducing applicable life-span of the paper shredder.

### SUMMARY OF THE INVENTION

A primary objective of the present invention is to provide another independent set of two cylindrical rotary cutters configured at a side of and linked up by means of a connecting gear to rotary cutters of a traditional paper shredder. A base of the traditional paper shredder is thereby configured to accommodate cutting tool sets comprising two paper shredding rotary cutters and two rotary cutters having grained surfaces pressed thereon. An electric motor and a decelerator drive the rotary cutters and thereby enable the paper shredder to operate therewith. The two sets of variant rotary cutters can separately fragment sheets of paper and compact discs, and because of utilization of independent sets of rotary cutters applicable life-span of the paper shredder fragmenting devices is assured. Wherein a cutting tool set for breaking compact discs is shorter than a cutting tool set for shredding paper, so to save the costs of produce.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a general view of a conventional product.

FIG. 2 shows a general view of a structure of the conventional product.

FIG. 3 shows a general view according to the present invention.

FIG. 4 shows a partial elevational view of a structure according to the present invention.

FIG. 5 shows a cross sectional view according to the present invention (shredding a sheet of paper).

FIG. 6 shows a cutaway schematic view of a cutting tool set (shredding a sheet of paper) according to the present invention.

FIG. 7 shows a cross sectional view according to the present invention (breaking up a compact disc).

FIG. 8 shows a cutaway schematic view of a cutting tool set (breaking up a compact disc) according to the present invention.

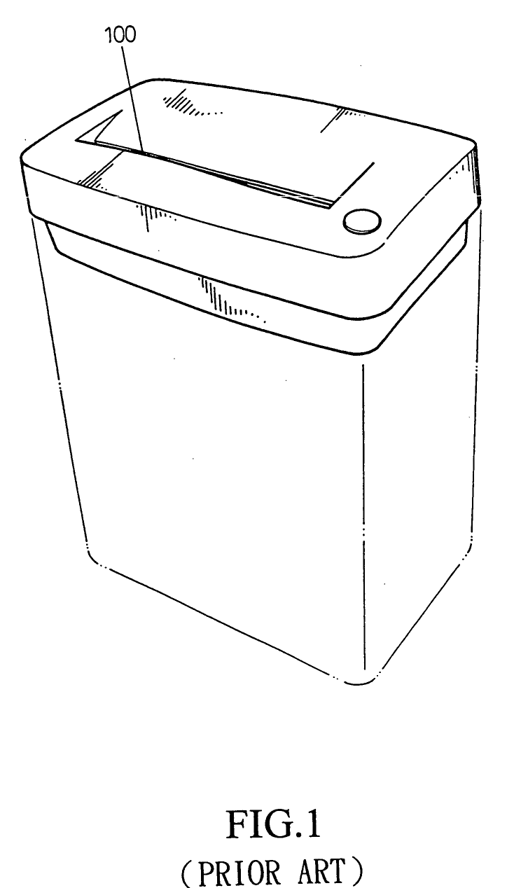

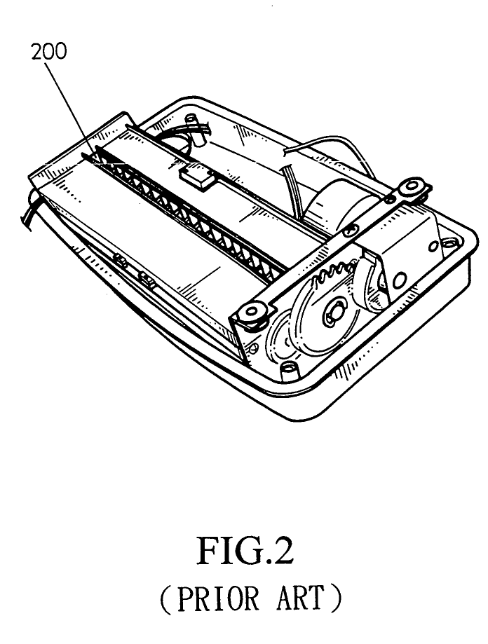

### DETAILED DESCRIPTION OF THE PREFERRED EMBODIMENTS

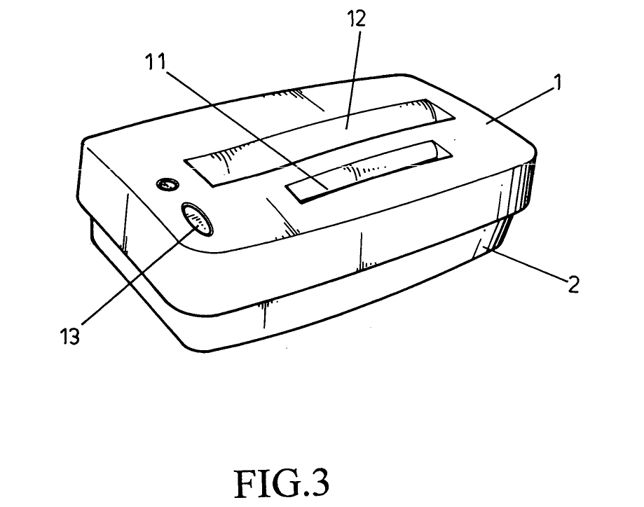

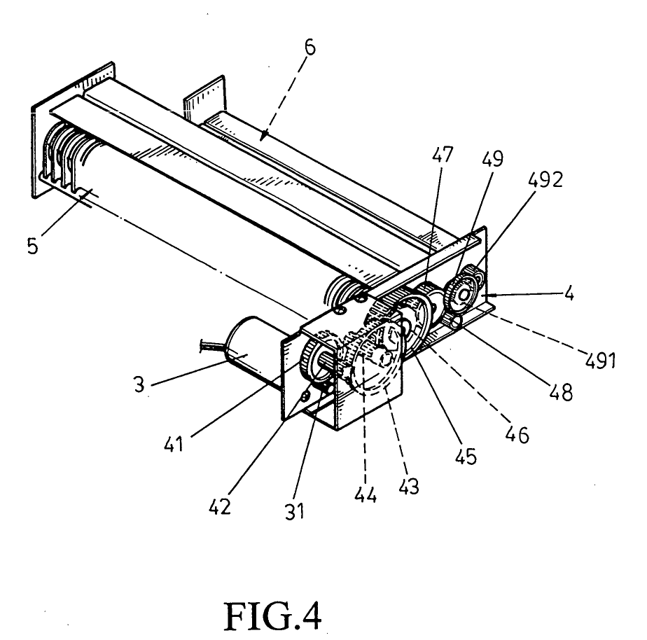

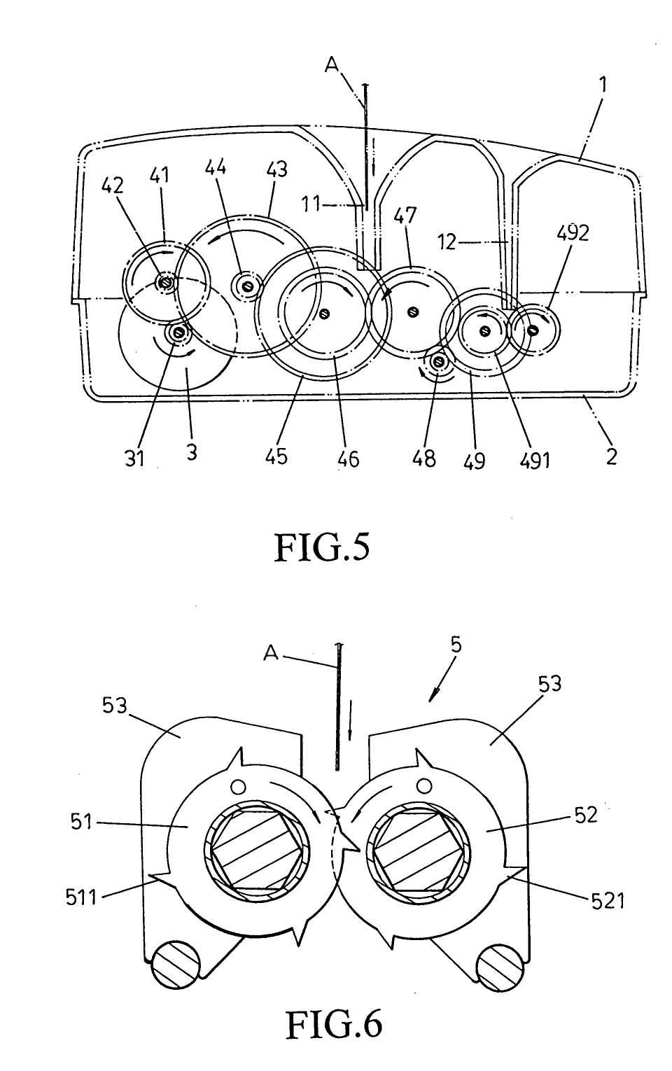

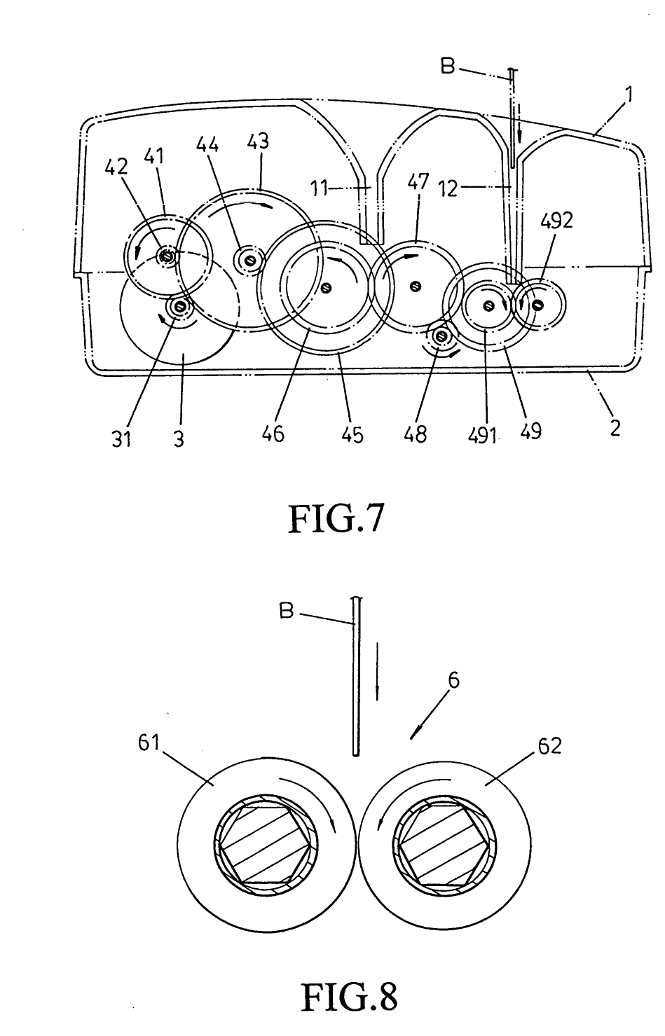

Referring to FIGS. 3 and 4, which show the present invention constructed to comprise components including a top cover 1, a base 2, an electric motor 3, a decelerator 4 and two cutting tool sets 5 and 6 (not shown).

Wherein, a paper insertion opening 11, a compact disc insertion opening 12 and a paper shredder switch 13 are defined in a top surface of the top cover 1 (see FIG. 3). An integrated circuit board, a cable and various circuit elements are fitted below the top cover 1. An interior of the base 2 is so designed to accommodate component positioning of the electric motor 3, the decelerator 4 and the two cutting tool sets 5 and 6. The cable connects the electric motor 3 to the integrated circuit board of the top cover 1 and the switch 13. The electric motor 3 also drives and thereby actuates the decelerator. The decelerator 4 comprises a decelerating structure configured to include a number of gears. A spindle 31 of the electric motor 3 is connected to a gear set of the decelerator 4. Referring to FIGS. 4 and 5, the gear set of the decelerator 4 drives and thereby rotates a gear 41 by means of the spindle 31 of the electric motor 3, and a gear 42 coaxial with gear 41 drives and thereby rotates a large gear 43. A small gear 44 coaxial with the large gear 43 drives and thereby rotates another large gear 45. A cutting tool gear 46 coaxial with the large gear 45 drives and thereby rotates a set of cutting blades 51 of the cutting tool set 5. The cutting tool gear 46 drives and thereby rotates a further cutting tool gear 47. The cutting tool gear 47 also drives and thereby rotates another set of cutting blades 52 of the cutting tool set 5. The present invention is characterized in that:

The aforementioned cutting tool gear 47 drives and thereby rotates a connecting gear 48, and the connecting gear 48 drives and thereby rotates another gear 49. A cutting tool gear 491 of the other cutting tool set 6 coaxial with the gear 49 drives and thereby rotates another cutting tool gear 492 at a side thereof. The two cutting tool gears 491 and 492 of the cutting tool set 6 separately drive and thereby rotate another two rotary cutters 61 and 62 of the cutting tool set 6. Because the cutting tool gears 46, 47, 491 and 492 are separately axially connected to the axles of the cutting tool sets 5 and 6, the decelerator 4 is enabled to drive and thereby rotate the two cutting tool sets 5 and 6. Referring to FIG. 6, the cutting tool set 5 is formed from mutual interlacing of the two sets of circular paper shredder cutting blades 51 and 52 peripherally configured with bayonet-like cutting edges 511 and 522. Paper guide plates 53 are installed in spacing between the paper shredder cutting blades 51 and 52. A sheet of paper A is inserted between the paper shredder cutting blades 51 and 52 through the paper insertion opening 11 defined in the top surface of the top cover 1, and thereupon is chopped and shredded. Referring to FIG. 4, the present invention is characterized that a cutting tool set 6 for breaking compact discs is shorter than a cutting tool set 5 for shredding paper, and thereupon the present invention can save the costs of produce.

Referring to FIG. 8, the cutting tool set 6 of another side comprises and is formed from two juxtapositioned cylindrical rotary cutters 61 and 62. Pressed grains are defined on surfaces of the rotary cutters 61 and 62. A compact disc B is inserted between the two rotary cutters 61 and 62 through the compact disc insertion opening 12 defined in the top surface of the top cover 1, and thereupon the compact disc B is mashed and broke up.

In conclusion, the present invention is structured to comprise the base 2 accommodating two disconnect-type fragmenting devices—a paper shredder device and a compact disc breaker device, and the connecting gear 48 to link up the two fragmenting devices. The two variant fragmenting devices respectively allow sheets of paper or compact discs to be inserted therein, and the sheets of paper or compact discs are thereupon separately shredded thereof. The present invention is characterized that a cutting tool set for breaking compact discs is shorter than a cutting tool set for shredding paper, and thereupon the present invention can save the costs of produce.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. Fragmenting devices for shredding paper and breaking compact discs
comprising elements including a top cover, a base, an electric motor, a decelerator and two cutting tool sets, wherein a paper insertion opening, and a compact disc insertion opening are defined in a top surface of the top cover; the electric motor, the decelerator and the two cutting tool sets are respectively positioned in the base, wherein the electric motor drives and thereby actuates the decelerator assembled from a number of gears, furthermore, the electric motor also drives and thereby controls rotation of gears of the two cutting tool sets, thereby enabling a shaft of a connecting gear to drive and thereby rotate the two cutting tool sets, two sets of circular paper shredder cutting blades are peripherally mounted with bayonet-like cutting edges, and the two paper shredder cutting blades engage in a mutual interlacing fashion; the connecting gear is configured lateral to and links up with the gears of the decelerator, and the connecting gear drives and thereby rotates another gear, and a cutting tool gear of the compact disc cutting tool set coaxial with the gear drives and thereby rotates another cutting tool gear at a side thereof, the two cutting tool gears separately drive and thereby rotate the set of rotary cutters therewith, the two cylindrical rotary cutters are mutually juxtaposed thereby forming a cutting tool set therefrom, and pressed grains are defined on surfaces of the rotary cutters, a compact disc is inserted between the two rotary cutters through the compact disc insertion opening defined in the top surface of the top cover, and thereupon the compact disc is mashed and broke up; and is characterized in that: a cutting tool set for breaking compact discs is shorter than a cutting tool set for shredding paper.
